(19) United States
(12) Patent Application Publication
(10) Pub. No.: US 2014/0053913 A1
(43) Pub. Date: Feb. 27, 2014

(54) OIL BYPASS VALVE

(71) Applicant: Ronald Wayne Dickey, Des Moines, IA (US)

(72) Inventor: Ronald Wayne Dickey, Des Moines, IA (US)

(21) Appl. No.: 13/910,663

(22) Filed: Jun. 5, 2013

Related U.S. Application Data
(60) Provisional application No. 61/693,612, filed on Aug. 27, 2012.

(51) Int. Cl. F16K 17/04

(52) U.S. Cl. CPC F16K 17/04
USPC 137/12; 137/504

(57) ABSTRACT

A bypass valve which may direct excess oil back into the cam chest where the return side of the oil pump may send the oil back into the oil tank. The bypass valve may fit within the bypass port of the cam plate and connect with a high pressure feed. The bypass valve may include a sleeve with a front opening and a needle valve within the bypass valve. The needle valve may be biased in a closed position, sealing off the front opening. When the high pressure feed exceeds a certain oil pressure, the needle valve may unblock the front opening.

### BACKGROUND OF THE INVENTION

The present invention relates to an oil bypass valve and, more particularly, to an oil bypass valve within a bypass port of a cam plate.

Certain motorcycle engines, such as stock Harley Davidson's® Twin Cam® oiling system, recirculates excessive oil pressure back into the low pressure oil pump feed. When the oil pressure exceeds 35 lbs the plunger is pushed back uncovering the drilled passage to the net (low pressure) side of the pump. This allows oil pumps generated air to be introduced into the motor. The recirculation may result in oil cavitation and a resulting drop in oil pressure, volume and quality.

As can be seen, there is a need for a valve to bypass the low pressure oil pump feed.

### SUMMARY OF THE INVENTION

In one aspect of the present invention, an oil bypass valve comprises: a hollow sleeve having a first end forming a front opening and a second end forming a rear opening; a needle valve having a front portion and a rear portion, wherein the needle valve is within the hollow sleeve, wherein the front portion has a larger diameter than the front opening; a spring around the rear portion of the needle valve, biasing the front portion of the needle valve against the front opening; and a cap having an opening, wherein the cap is attached to the second end of the oil bypass valve, wherein the cap secures the spring within the hollow sleeve, wherein the oil bypass valve comprises a closed configuration and an opening configuration, wherein the closed configuration comprises a blocked front opening, and the open configuration comprises an unblocked front opening.

In another aspect of the present invention, a method of bypassing a low pressure feed comprising: removing a plunger from a bypass port of a cam plate; providing an oil bypass valve comprising: a hollow sleeve having a first end forming a front opening and a second end forming a rear opening; a needle valve having a front portion and a rear portion, wherein the needle valve is within the hollow sleeve, wherein the front portion has a larger diameter than the front opening; a spring around the rear portion of the needle valve, biasing the front portion of the needle valve against the front opening; and a cap having an opening, wherein the cap is attached to the second end of the oil bypass valve, wherein the cap secures the spring within the hollow sleeve; inserting the oil bypass valve into the bypass port of the cam plate; connecting the oil bypass valve to a high pressure feed on an oil pump; and bypassing a low pressure feed of the oil pump, wherein about 35 lbs of oil pressure applied to the needle valve pushes the needle valve towards the cap and the opening is unblocked, thereby oil passes through the hollow sleeve, out of the cap and into the bypass port.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is an exploded view of the embodiment of FIG. 1;

FIG. 3 is a section view of the present invention, taken along line 3-3 of FIG. 1;

FIG. 4 is a section view of the present invention, taken along line 4-4 in FIG. 1;

FIG. 5 is a section view of the present invention, illustrating the movement of oil past the flutes of FIG. 2;

FIG. 6 is a side view of the present invention, illustrating the insertion of the valve of FIG. 1 within a cam plate; and

FIG. 7 is a section view of the cam plate, showing the position of the valve of FIG. 1 within the cam plate.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a bypass valve which may direct excess oil back into the cam chest where the return side of the oil pump may send the oil back into the oil tank. The bypass valve may fit within the bypass port of the cam plate and connect with a high pressure feed. The bypass valve may include a sleeve with a front opening and a needle valve within the bypass valve. The needle valve may be biased in a closed position, sealing off the front opening. When the high pressure feed exceeds a certain oil pressure, the needle valve may unblock the front opening.

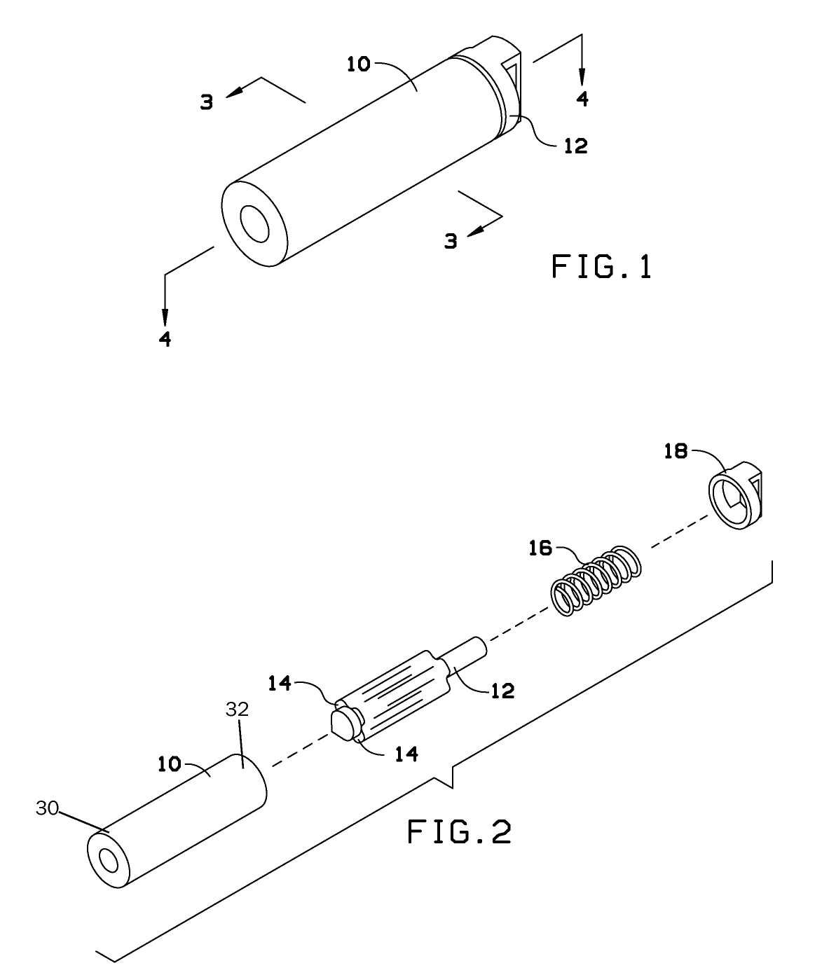

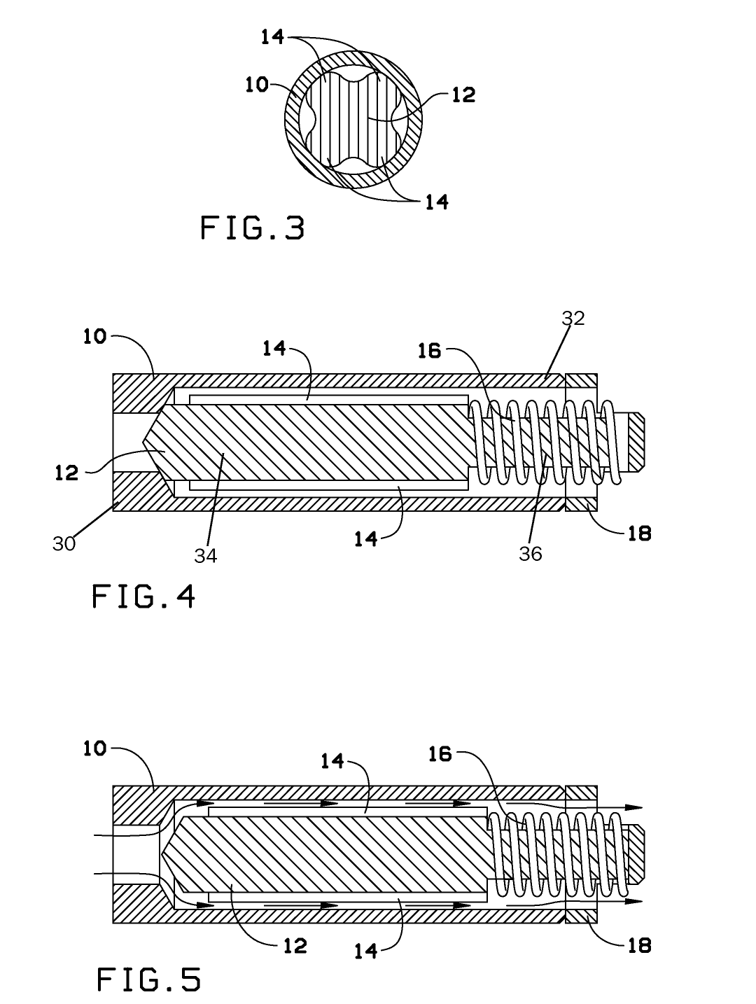

Referring to FIGS. 1 through 7, the present invention may include a sleeve 10. The sleeve 10 may be made of metal, such as steel. The sleeve 10 may be hollow in the center. The sleeve 10 may include a first end 30 and a second end 32. The first end 30 may form a front opening and the second end 32 may form a rear opening. The front opening may include a smaller diameter than the rear opening.

The present invention may further include a needle valve 12. The needle valve 12 may fit within the hollow center of the sleeve 10. The needle valve 12 may include a front portion 34 and a rear portion 36. The front portion 34 may include a larger diameter than the front opening of the sleeve 10 and may thereby not pass through the front opening. The front portion 34 may further include flutes 14 forming channels in between. The rear portion 36 of the needle 12 may be smaller in diameter than the front portion 34. A spring 16 may fit around the rear portion 36 and may rest against the flutes 14.

In certain embodiments, the present invention may further include a cap 18. The cap 18 may fit onto the second end 32 of the sleeve 10. When the cap 18 is secured to the second end 32 of the sleeve 10, the spring 16 may push the front portion 34 of the needle valve 12 against the front opening of the sleeve 10. Thereby, the needle valve 12 is biased so that the front opening is in a closed position. The length of the needle 12 is smaller than the length of the sleeve 10 with the cap 18 attached. Therefore, when pressure is applied to the needle valve 12, the needle valve 12 may be pushed backwards and the front opening may be in an open position, with the rear portion 36 of the needle valve 12 pressed up against the cap 18. The cap 18 may include at least one opening. Therefore, a liquid may pass through the front opening through the channels and through the openings in the cap 18 when the front opening is in an open position.

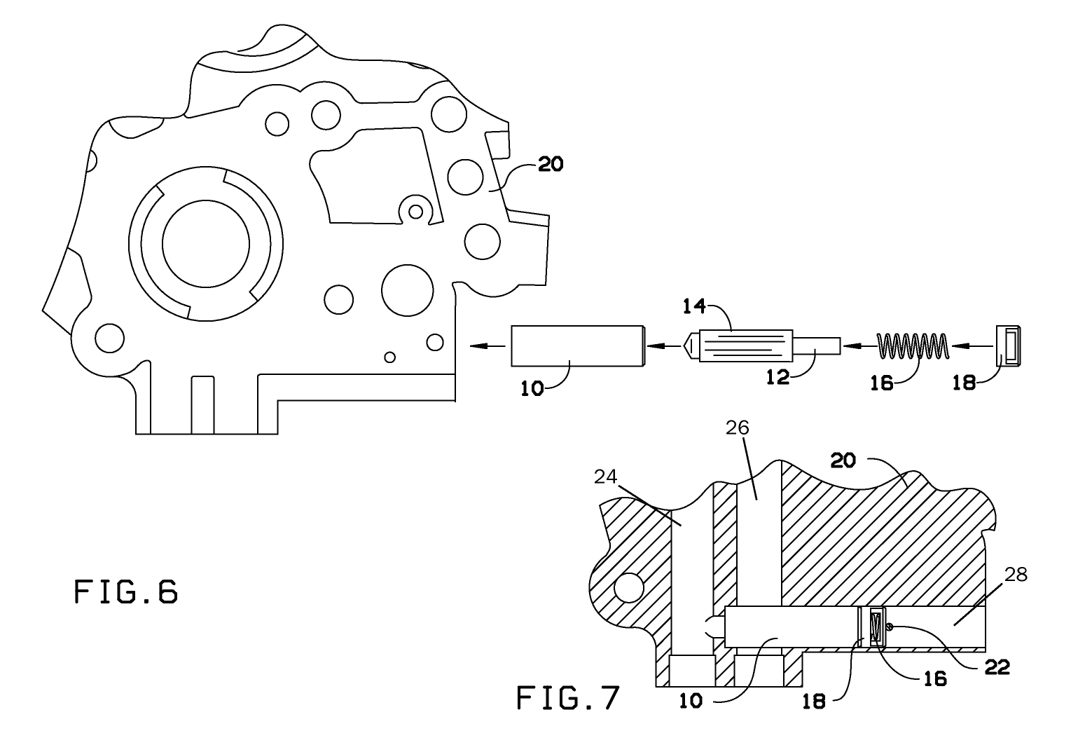

As illustrated in FIGS. 6 and 7, the present invention may be inserted into a stock cam plate 20. The sleeve 10 may be inserted into the bypass port 28 of the stock cam plate 20. The front opening of the sleeve 10 may be connected to the high pressure feed 24 of the oil pump. The outside surface of the sleeve 10 may cover the low pressure feed 26 and thereby bypass the low pressure feed 26 within the bypass port 28. When a certain amount of oil pressure builds up in the high pressure feed 24, such as 35 lbs, the needle valve 12 may be pushed back and the oil may enter the front opening, bypass the low pressure feed 26, travel through the channels in between the flutes 14 and exit into the bypass port 28 through the openings in the cap 16. The present invention thereby directs the oil into the cam chest and not back into the oil pump.

A method of making the present invention may include the following. The sleeve may be machined from steel and the outside diameter and length may be held to close tolerances to prevent leaks. The inside diameter may provide proper clearance with the needle valve. The front opening may include the dimensions to conform with the needle valve so that the needle valve may seal the front opening. The needle valve may include an outside diameter to have proper clearance with sleeve. The needle valve length may be accurate for the needed spring pre-load. The spring may retain its shape and may be durable for longevity. The cap may fit on the sleeve and may retain the spring. To install the present invention, a mechanic may remove the stock bypass valve and spring, and then install the present invention in their place.

A method of bypassing a low pressure feed may include the following: removing a plunger from a bypass port of a cam plate; providing an oil bypass valve comprising: a hollow sleeve having a first end forming a front opening and a second end forming a rear opening; a needle valve having a front portion and a rear portion, wherein the needle valve is within the hollow sleeve, wherein the front portion has a larger diameter than the front opening; a spring around the rear portion of the needle valve, biasing the front portion of the needle valve against the front opening; and a cap having at least one opening, wherein the cap is attached to the second end of the oil bypass valve, wherein the cap secures the spring within the hollow sleeve; inserting the oil bypass valve into the bypass port of the cam plate; connecting the oil bypass valve to a high pressure feed on an oil pump; and bypassing a low pressure feed of the oil pump, wherein about 35 lbs of oil pressure applied to the needle valve pushes the needle valve towards the cap and the opening is unblocked, thereby oil passes through the hollow sleeve, out of the cap and into the bypass port.

It should be understood, of course, that the foregoing relates to exemplary embodiments of the invention and that modifications may be made without departing from the spirit and scope of the invention as set forth in the following claims.

What is claimed is:

1. An oil bypass valve comprising:
a hollow sleeve having a first end forming a front opening and a second end forming a rear opening;
a needle valve having a front portion and a rear portion, wherein the needle valve is within the hollow sleeve, wherein the front portion has a larger diameter than the front opening;
a spring around the rear portion of the needle valve, biasing the front portion of the needle valve against the front opening; and
a cap having at least one opening, wherein the cap is attached to the second end of the oil bypass valve, wherein the cap secures the spring within the hollow sleeve,
wherein the oil bypass valve comprises a closed configuration and an opening configuration, wherein the closed configuration comprises a blocked front opening, and the open configuration comprises an unblocked front opening.

2. The oil bypass valve of claim 1, wherein the front portion of the needle valve comprises flutes forming channels in between.

3. The oil bypass valve of claim 1, wherein the needle valve has a smaller length than the hollow sleeve with the cap.

4. The oil bypass valve of claim 1, wherein the oil bypass valve converts from the closed configuration to the open configuration at an oil pressure of around 35 lbs and above.

5. The oil bypass valve of claim 1, further comprising a bypass port of a cam plate, wherein the oil bypass valve is within the bypass port of the cam plate.

6. The oil bypass valve of claim 5, wherein the oil bypass valve is connected to a high pressure feed of an oil pump within the cam plate, and wherein the oil bypass valve bypasses a low pressure feed and leads oil into the bypass port.

7. A method of bypassing a low pressure feed comprising:
removing a plunger from a bypass port of a cam plate;
providing an oil bypass valve comprising:
a hollow sleeve having a first end forming a front opening and a second end forming a rear opening;
a needle valve having a front portion and a rear portion, wherein the needle valve is within the hollow sleeve, wherein the front portion has a larger diameter than the front opening;
a spring around the rear portion of the needle valve, biasing the front portion of the needle valve against the front opening; and
a cap having an opening, wherein the cap is attached to the second end of the oil bypass valve, wherein the cap secures the spring within the hollow sleeve;
inserting the oil bypass valve into the bypass port of the cam plate;
connecting the oil bypass valve to a high pressure feed on an oil pump; and
bypassing a low pressure feed of the oil pump, wherein abour 35 lbs of oil pressure applied to the needle valve pushes the needle valve towards the cap and the opening is unblocked, thereby oil passes through the hollow sleeve, out of the cap and into the bypass port.
